(19) United States
(12) Patent Application Publication
(10) Pub. No.: US 2007/0165658 A1
(43) Pub. Date: Jul. 19, 2007

(54) Transmission apparatus, transmission-channel-ring connecting method, and computer product

(75) Inventor: Ryoichi Mutoh, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/431,351

(22) Filed: May 10, 2006

(30) Foreign Application Priority Data
Jan. 19, 2006 (JP) 2006-011654

(51) Int. Cl. H04L 12/28

(52) U.S. Cl. 370/403

(57) ABSTRACT

A transmission apparatus arranged on one packet ring connects the packet ring and the other packet ring by performing an acquiring step for acquiring connection information of the other packet ring and the own apparatus and a notifying step for notifying other transmission apparatuses arranged on the packet ring of redundant configuration information indicating a status of the interconnection between the packet ring and the other packet ring, based on the connection information.

### CROSS-REFERENCE TO RELATED APPLICATIONS

This application is based upon and claims the benefit of priority from the prior Japanese Patent Application No. 2006-011654, filed on Jan. 19, 2006, the entire contents of which are incorporated herein by reference.

### BACKGROUND OF THE INVENTION

1. Field of the Invention

The present invention relates to a technology for connecting transmission channel rings using plural transmission apparatuses.

2. Description of the Related Art

Recently, instead of synchronous optical network/synchronous digital hierarchy (SONET/SDH), a packet ring has been attracting attention. The packet ring directly processes packets on a transmission channel rings. The packet ring is constituted by disposing pluralities of transmission apparatuses (stations) on a unidirectional or bidirectional transmission channel ring. Each transmission apparatus sends out data packets and control frames directly to the ring to transmit information. A typical mode of such packet ring transmission includes a resilient packet ring (RPR) standard standardized by IEEE 802.17 committee.

The RPR creates a dual ring configuration by reversely combining two transmission channel rings sending out packets in one direction to provide a band-shared packet ring. The RPR has the following three major features. First, a fairness algorithm is provided for ensuring fairness of best effort traffics that do not guarantee communication quality. Second, by using ring protections called steering and wrapping, if a failure occurs in a packet ring, a failure protection can be quickly switched for recovery within 50 milliseconds (ms). Third, plug-and-play is achieved by a topology discovery function that automatically recognizes a ring topology (connection form of a transmission channel ring), without manual setup operation of a user.

The Ethernet (registered trademark) and SONET/SDH are employed on the physical layer of the RPR, and one packet ring can be provided with up to 255 stations (network apparatuses such as transmission apparatuses). IEEE 802 48-bit media access control (MAC) addresses (compliant with IEEE std. 802-2002) are used for the identifiers of the stations.

FIG. 13 is a schematic of conventional inter-packet ring connection. As shown in FIG. 13, when a packet ring R10 provided with transmission apparatuses 131 to 135 is connected with a packet ring R20 provided with transmission apparatuses 136 to 140, the transmission apparatus 133 is connected with the transmission apparatus 139, and the transmission apparatus 134 is connected with the transmission apparatus 140. To ensure a redundancy of connection locations, generally, pluralities of transmission apparatuses are arranged to interconnect packet rings (for example, Japanese Patent Application Laid-Open Publication No. 2003-258822).

However, as shown in FIG. 13, if the interconnection portion of the packet rings is made redundant, an additional loop R30 is created between the packet ring R10 and the packet ring R20. That causes network failures such as undelivered packets due to erroneous channel learning and congestions due to a broadcast storm.

It is necessary to separately acquire information on the transmission apparatuses (133, 134, 139, and 140) of the connection portion between the packet rings forming the redundant configuration using manual setting or automatic setting. If the manual setting is applied, it is less convenient and erroneous setting may be caused, resulting in burden on network administrators and users. Therefore, the automatic setting is preferable. However, if the automatic setting is performed, the transmission apparatuses connecting the packet rings must acquire the information of the redundant configuration.

### SUMMARY OF THE INVENTION

It is an object of the present invention to at least solve the above problems in the conventional technologies.

A transmission apparatus according to one aspect of the present invention is arranged on a transmission channel ring on which pluralities of transmission apparatuses are arranged. The transmission apparatus includes an acquiring unit configured to acquire connection information indicative of a connection state of the transmission apparatus with another transmission channel ring other than the transmission channel ring; and a notifying unit configured to notify, to others of the transmission apparatuses arranged on the transmission channel ring, an interconnection state between the transmission channel ring and the other transmission channel ring based on the connection information by transmitting redundant configuration information indicative of the interconnection state.

A method according to another aspect of the present invention is of connecting transmission channel rings on which pluralities of transmission apparatuses are arranged. The method includes acquiring connection information indicative of a connection state of the transmission apparatus with another transmission channel ring other than the transmission channel ring; and notifying, to others of the transmission apparatuses arranged on the transmission channel ring, an interconnection state between the transmission channel ring and the other transmission channel ring based on the connection information by transmitting redundant configuration information indicative of the interconnection state.

A computer-readable recording medium according to still another aspect of the present invention stores therein a computer program for realizing a method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an inter-packet ring connection using transmission apparatuses according to an embodiment of the present invention;

FIG. 2 is a table for illustrating a ring topology database in the transmission apparatus;

FIG. 3 is a flowchart of an identification (ID)-frame transmission process performed between the packet rings;

FIG. 4 is a flowchart of an ID-frame reception process performed between the packet rings;

FIG. 5 is a flowchart of an ID-frame transmission process performed between the packet rings;

FIG. 6 is a flowchart of an ID-frame reception process performed between the packet rings;

FIG. 7 is a schematic of an inter-packet ring connection using an attribute discovery (ATD) frame;

FIG. 8A is a schematic for illustrating a format of the ATD frame;

FIG. 8B is a schematic for illustrating a payload of the ATD frame;

FIG. 9 is a schematic for illustrating a connection failure between packet rings;

FIG. 10 is a flowchart of a process by a backup-system (STANDBY) transmission apparatus at the time of occurrence of connection failure between packet rings having the 1+1 redundant configuration;

FIG. 11 is a schematic for illustrating a transmission failure of the transmission apparatus;

FIG. 12 is a flowchart of a process by a backup-system (STANDBY) transmission apparatus having 1:1 redundant configuration in the connection destination ring at the time of occurrence of the transmission failure in the transmission apparatus; and

FIG. 13 is a schematic of a conventional inter-packet ring connection.

### DETAILED DESCRIPTION OF THE PREFERRED EMBODIMENTS

Exemplary embodiments according to the present invention will be explained in detail below with reference to the accompanying drawings.

A transmission apparatus according to embodiments of the present invention transmits and receives information on inter-packet ring connection by means of an ID frame that is a control frame formed in a predetermined data format. This ID frame includes interconnection (redundant configuration) information of the transmission apparatus and notifies each transmission apparatus on the same packet ring of the information.

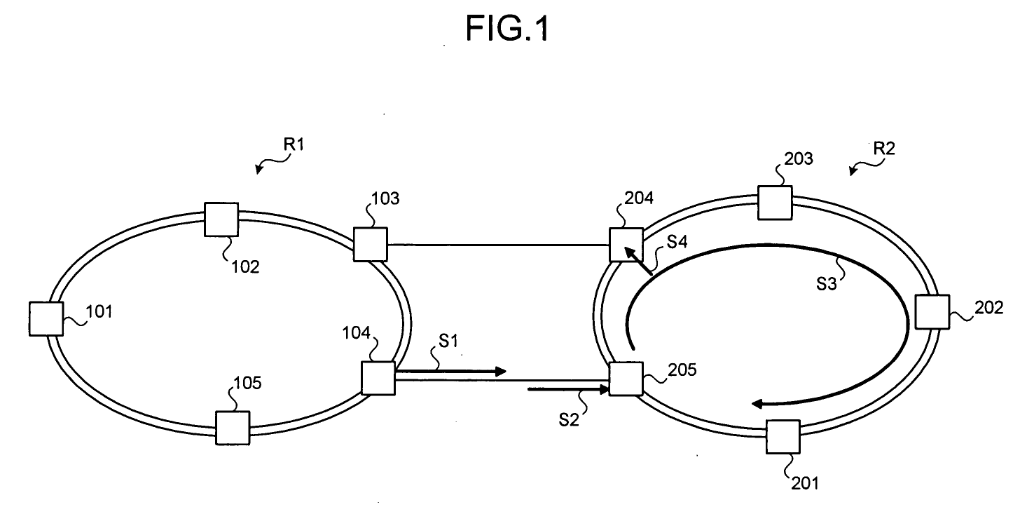

FIG. 1 is a schematic of an inter-packet ring connection using the transmission apparatuses according to the embodiment of the present invention. Description will be made of an example of connecting a packet ring R1 and a packet ring R2. The packet ring R1 is provided with five stations that are transmission apparatuses 101 to 105. The packet ring R2 is provided with five stations, which are transmission apparatuses 201 to 205. The packet ring R1 and the packet ring R2 are connected by the transmission apparatus 103 and the transmission apparatus 204 as well as the transmission apparatus 104 and the transmission apparatus 205.

Each of the transmission apparatuses 101 to 105, 201 to 205 includes an acquiring unit that acquires connection information of the packet ring and respective apparatus, a notifying unit that notifies redundant configuration information indicating an interconnection status of the transmission channel ring on which the respective apparatus is arranged with respect to another packet ring, and a receiving unit that receives the redundant configuration information from other transmission apparatuses arranged on the same transmission channel ring. The transmission apparatus further includes a transmitting unit that transmits connection information of the packet ring on which the apparatus is arranged to the transmission apparatuses arranged on another packet ring.

First, an ID frame is transmitted from the transmission apparatus 104 of the packet-ring R1, which is a transmission apparatus (hereinafter, “interconnecting transmission apparatus”) interconnecting two packet rings R1 and R2 (S1), and is received by the transmission apparatus 205 of the packet ring R2 (S2). With this process, the transmission apparatus recognizes that the apparatus acts as the interconnecting transmission apparatus that connects the packet rings. The transmission apparatus recognizes to which packet ring the transmission apparatus is connected, based on a ring ID in the ID frame. The ring ID identifies the packet ring where the counterpart transmission apparatus is arranged. By performing such a process periodically, it is possible to confirm that the connection between the rings is maintained.

The ID frame includes interconnection information of the transmission apparatus and provides each transmission apparatus on the same packet ring of the information (S3). Thus, the transmission apparatus interconnecting the packet ring R1 and packet ring R2 recognizes other transmission apparatuses for interconnection based on the ID frame received from the transmission apparatus of the connection destination (S4). The interconnection information of the transmission apparatuses arranged on different packet rings may include a ring ID of an interconnection destination in addition to whether the transmission apparatus is the interconnecting transmission apparatus for pluralities of the rings. The ring ID is unique identification information defined for each packet ring.

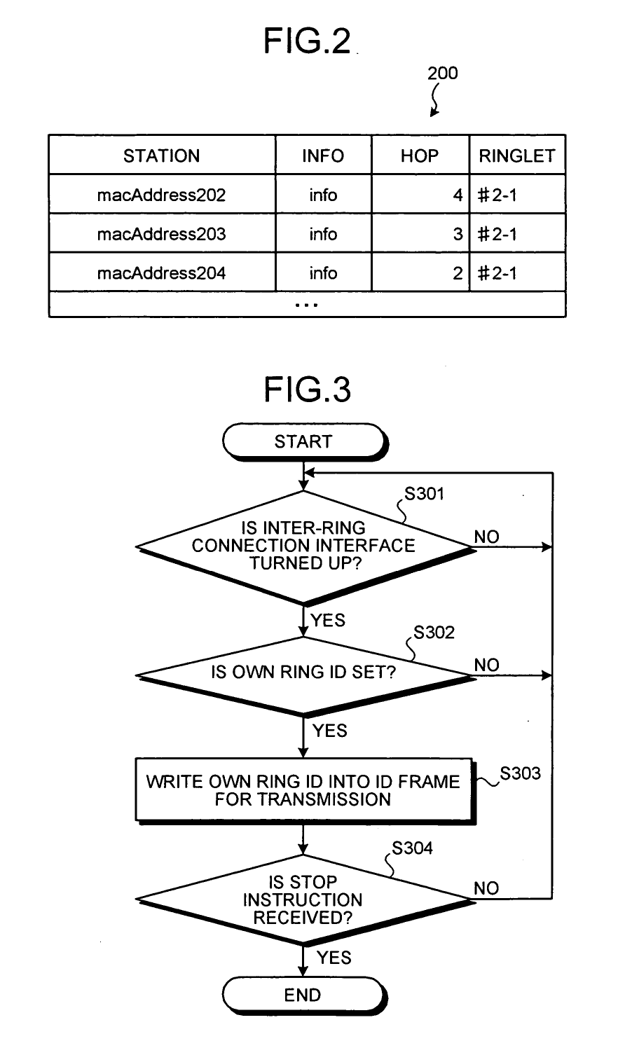

When receiving the interconnection information, each transmission apparatus arranged on the packet ring creates a ring topology database for checking a connection form of the packet ring, which is maintained on a predetermined data table. FIG. 2 is a table for illustrating a ring topology database in the transmission apparatus. A data table 200 illustrates a topology data base of the transmission apparatus 201 arranged on the packet ring R2 shown in FIG. 1.

The data table 200 includes information of other transmission apparatuses arranged on the same packet ring (STATION), types of information (INFO), the number of relaying transmission apparatuses (HOP), and connection statuses (RINGLET). In the ringlet, “#2” represents a packet ID and “−1” represents the direction of the packet transmission (“1” is clockwise and “2” is anticlockwise). That is, the data table 200 represents that the transmission apparatus 201 arranged on the packet ring R2 has the transmission apparatus 204 located after two apparatuses and the transmission apparatus 203 located after three apparatuses in the clockwise direction.

Description will be made of the process (S1) of transmitting the ID frame from the transmission apparatus 104 arranged on the packet ring R1, the process (S2) of receiving the ID frame with the transmission apparatus 205 arranged on the packet ring R2, the process (S3) of transmitting the ID frame from the transmission apparatus 205 arranged on the packet ring R2, and the process (S4) of receiving the ID frame with the transmission apparatus 204 arranged on the packet ring R2.

FIG. 3 is a flowchart of an ID-frame transmission process between the packet rings. The transmission apparatus 104 determines whether an inter-ring connection interface is turned up (activated) (step S301). If not, it is waited until the inter-ring connection interface is turned up (step S301: NO). If the inter-ring connection interface is turned up (step S301: YES), it is then determined whether an own ring ID has been set (step S302).

If the own ring ID has been set at step S302 (step S302: YES), the own ring ID is written into the ID frame and transmitted (step S303). If the own ring ID has not been set (step S302: NO), the procedure goes back to step S301 and enters into a standby state until the inter-ring connection interface is turned up.

Finally, it is determined whether a stop instruction is received or not (step S304), and if the stop instruction is received (step S304: YES), a series of processes is terminated. If the stop instruction is not received (step S304: NO), the procedure goes back to the process of step S301 and enters into a standby state until the transmission process is performed for the next ID frame. If the standby state is continued for a predetermined time period, the transmission apparatus 104 enters into a standby state of a power-saving mode (sleep state) and the procedure goes back to the process of step S301.

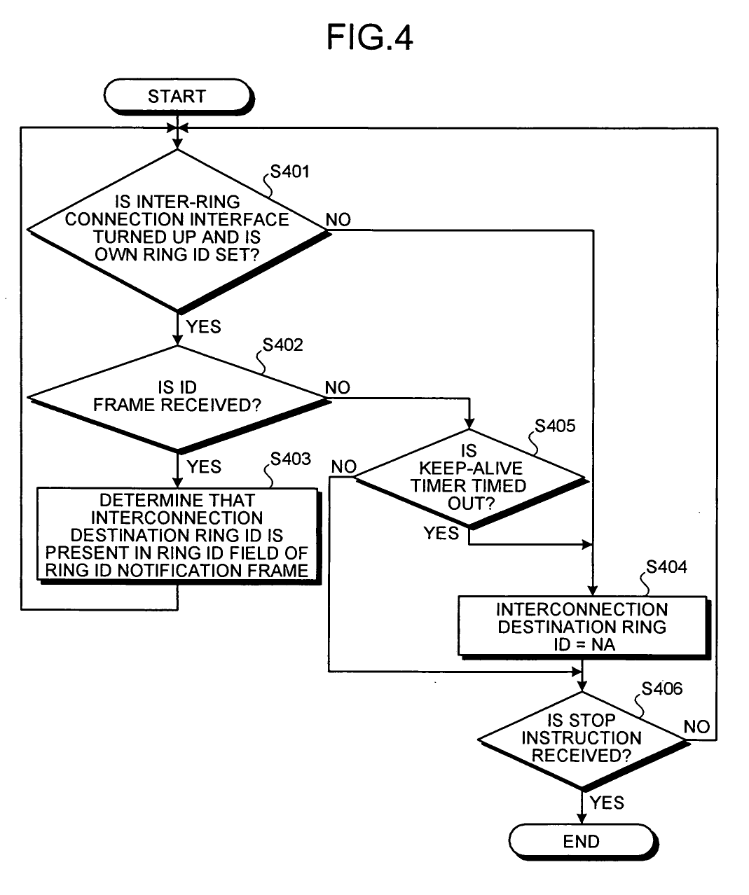

The transmission apparatus 205 receives the ID frame transmitted to the packet ring R2 in the process described in FIG. 3. FIG. 4 is a flowchart of an ID frame reception process between the packet rings. The transmission apparatus 205 determines whether the inter-ring connection interface is turned up, and whether an own ring ID has been set (step S401).

If the inter-ring connection interface is turned up and the own ring ID has been set (step S401: YES), it is determined whether the ID frame is received (step S402). If the ID frame is received (step S402: YES), it is determined that the ring ID of the interconnection destination is present in a ring ID field of the ID frame (step S403), and the procedure goes back to the process of step S401.

If the inter-ring connection interface is not turned up, or that the own ring ID has not been set (step S401: NO), it is determined that the ring ID of the interconnection destination is in “N/A” (no data is available) state indicating that the interconnection information is currently invalid (step S404), and the procedure goes to the process of step S406.

If the ID frame is not received at step S402 (step S402: NO), it is determined whether a keep-alive timer is timed out (step S405). The keep-alive timer is used to determine an operation state of the transmission apparatus connecting the packet rings. The transmission apparatus receives (transmits) a keep-alive packet periodically. If the keep-alive packet is not detected for a predetermined period or more (in the case of time-out), it is determined that the operation of the transmission apparatus is ceased.

If it is determined that the keep-alive timer is timed out (step S405: YES), it is determined that the ring ID of the interconnection destination is in the NA state (step S404), and the procedure goes to the process of step S406. If the keep-alive timer is not timed out (step S405: NO), it is determined whether a stop instruction is received a user or a network administrator (step S406).

If the stop instruction is received at step S406 (step S406: YES), a series of the processes is terminated. If the stop instruction is not received (step S406: NO), the procedure goes back to step S401 to repeat the reception process.

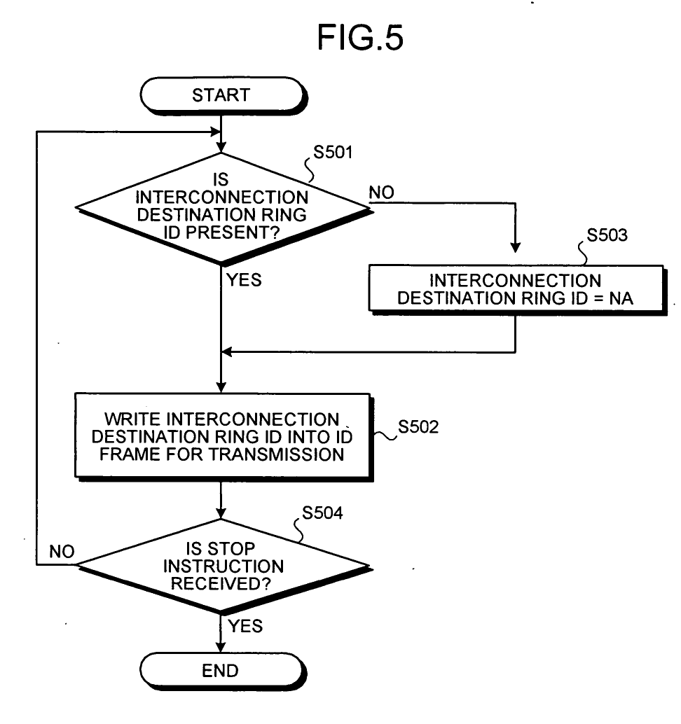

FIG. 5 is a flowchart of the ID-frame transmission process within the packet ring. The transmission apparatus 205 determines whether the ring ID of the interconnection destination is present (step S501). If the ring ID of the interconnection destination is present (step S501: YES), the ring ID of the interconnection destination is written into the ID frame and transmitted within the same ring (step S502). This transmission process is performed correspondingly to the transmission direction of each packet ring. Therefore, in the case of packet ring R2, the transmission to each transmission apparatus is performed in the clockwise direction.

If the ring ID of the interconnection destination is not present (step S501: NO), it is determined that the ring ID of the interconnection destination is in the NA state (step S503), and the procedure goes to the process of step S502.

Finally, it is determined whether a stop instruction is received (step S504), and if the stop instruction is received (step S504: YES), a series of the processes is terminated. If the stop instruction is not received (step S504: NO), the procedure goes back to step S501 and enters into a standby state to maintain the intervals of the ID frame transmission at step S502. If the standby state is continued for a predetermined time period or more, the transmission apparatus 104 goes back to the process of step S501.

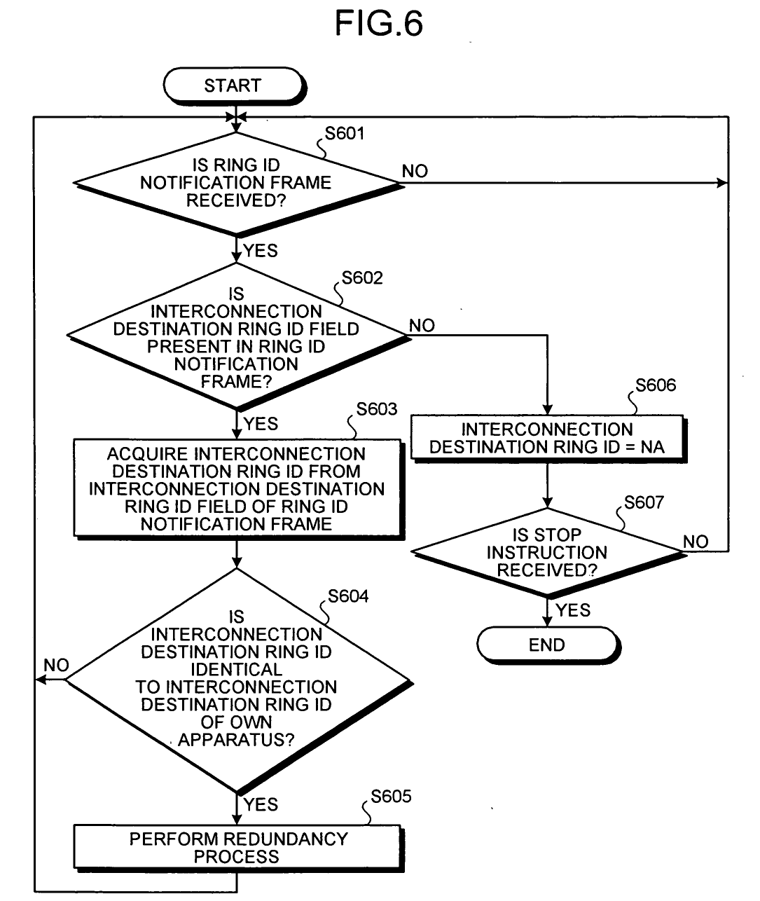

FIG. 6 is a flowchart of the ID frame reception process within the packet ring. In the flowchart of FIG. 6, the transmission apparatus (for example, transmission apparatus 204) determines whether the ID frame is received from the transmission apparatus 205 (step S601).

If the ID frame is received (step S601: YES), it is determined whether the ring ID field of the interconnection destination is present in the ID frame (step S602). If the ID frame is not received at step S601 (step S601: NO), the procedure goes back to step S601 and enters into the standby state until the ID frame is received.

If the ring ID field of the interconnection destination is present at step S602 (step S602: YES), the ring ID of the connection destination of the transmission apparatus 205 is acquired from the ring ID field of the interconnection destination of the ID frame (step S603). If the ring ID field of the interconnection destination is not present (step S602: NO), it is determined that the ring ID of the interconnection destination is in the NA state (step S606), and the procedure goes to the process of step S607.

After the process of step S603, it is determined whether the interconnection destination ring ID of the transmission apparatus 205 is identical to the ring ID of the interconnection destination of the own apparatus (transmission apparatus 204) (step S604). If the ring IDs are identical (step S604: YES), it is determined that the transmission apparatus 204 is the transmission apparatus connecting the same packet rings, and a redundancy process is performed (step S605). If the ring IDs are not identical (step S604: NO), the procedure goes back to the process of step S601 and enters into the standby state until the ID frame is received.

After completing the process of step S606, it is determined whether a stop instruction is received from a user or a network administrator (step S607).

If the stop instruction is received (step S607: YES), a series of the processes is terminated. If the stop instruction is not received (step S607: NO), the procedure goes back to step S601 to repeat the reception process.

The above transmission/reception process of the ID frame is performed to interconnect the packet rings (R1, R2).

In the RPR, each transmission apparatus always recognizes a ring topology through the control frame to detect changes and failures in the network. Each transmission apparatus on the packet ring broadcasts a topology and protection (TP) frame periodically (a recommendation value is 100 ms) or when a status of a station or ring is changed.

Particularly, an ATD frame can be used to exchange additional information. Since the data unit of the ATD frame is a type length value (TLV) format called additional station attributes (ATT), the redundancy configuration information can be newly added to the ATT of the ATD frame to notify each transmission apparatus on the packet ring in the same RPR of the own interconnection information.

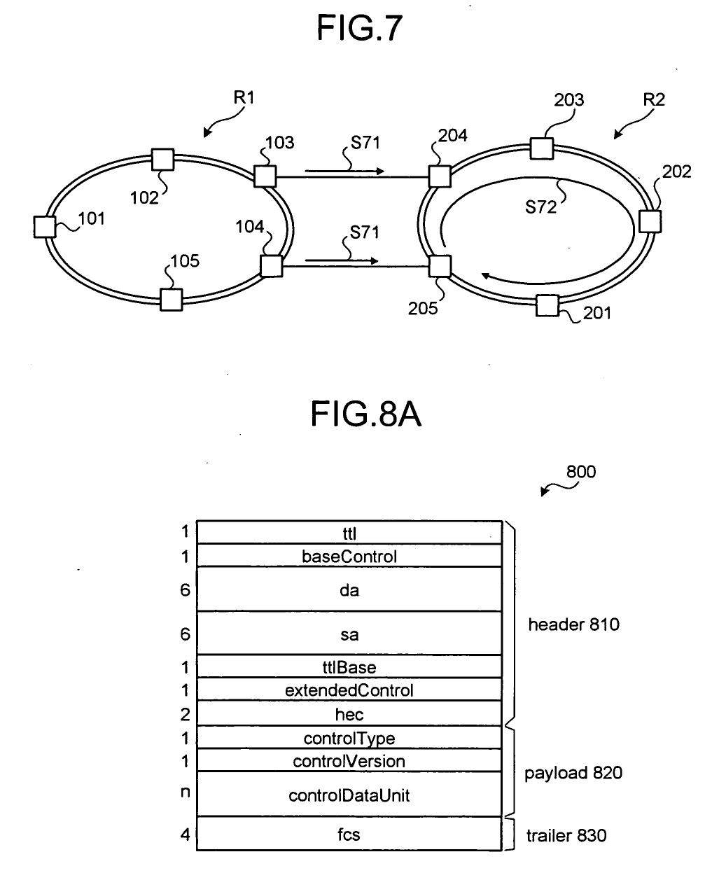

FIG. 7 is a schematic of an inter-packet ring connection using the ATD frame. As shown in FIG. 7, two packet rings (R1, R2) of the RPR are interconnected using Ethernet (registered trademark) between the transmission apparatus 103 and the transmission apparatus 204 as well as between the transmission apparatus 104 and the transmission apparatus 205. When connecting, the ATD frame is used for a ring ID frame transmitted among the transmission apparatuses.

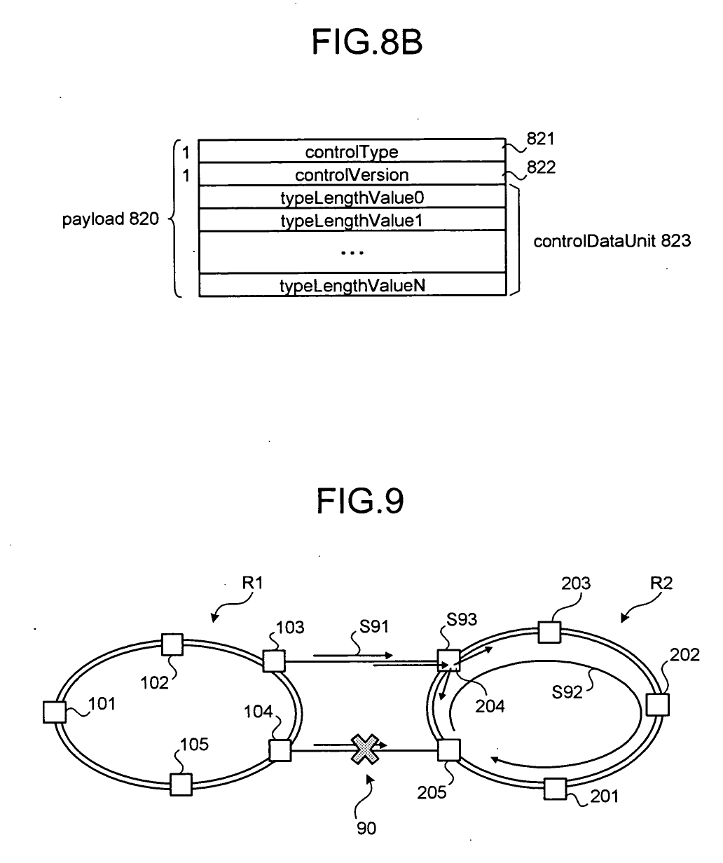

FIG. 8A is a schematic for illustrating a format of the ATD frame. A data table 800 includes a header 810, a payload 820, and a trailer 830.

FIG. 8B is a schematic for illustrating a payload of the ATD frame. The payload 820 includes a control type 821, a control version 822, and a control data unit 823. The control Data Unit 823 stores a type length value to store information corresponding to the ATD frame.

In the ring ID setting, provisioning (preliminary setup) of unique ring IDs (for example, R1, R2) is performed for several transmission apparatuses (at least the transmission apparatuses 103, 104, 204, 205) in a network including pluralities of packet rings of the RPR.

To exchange the ring ID of the packet ring, first, from an interface connecting the RPR packet ring and another network, the transmission apparatus transmits a keep-alive packet into which the ring ID has been written. For example, the transmission apparatus 103 and the transmission apparatus 104 transmit the keep-alive packets including the own ring ID (information indicating R1) to the transmission apparatus 204 and the transmission apparatus 205, respectively (S71 shown in FIG. 7).

On the other hand, the transmission apparatus 204, 205 receives the keep-alive packet from the opposite transmission apparatus 103, 104 and recognizes that the apparatus itself is a ring interconnection transmission apparatus of the packet rings. The ring ID of the connection destination is learned from the ring ID included in the keep-alive packet received from the opposite interconnected transmission apparatus. For example, the transmission apparatus 204 and the transmission apparatus 205 can recognize the interconnected with the packet ring R1 from the keep-alive packets received from the transmission apparatus 103 and the transmission apparatus 104, respectively. Thus, the keep-alive packets are exchanged periodically. With this process, it is possible to confirm that the connection between the packet rings is maintained.

By transmitting the ATD frame, the transmission apparatus notifies each transmission apparatus on the same RPR ring of the own interconnection information (S72 shown in FIG. 7). For example, the transmission apparatus 204 and the transmission apparatus 205 transmit the ATD frames including the interconnection destination ring ID (packet ring R1) to the packet ring R2.

Since the interconnection information of the ATD frame is ignored by a transmission apparatus of the RPR not supporting the ATD frame mode or a transmission apparatus not interconnected with the packet rings, the interconnection with the conventional transmission apparatuses is also maintained.

The interconnection transmission apparatus receives the ATD frame including the interconnection information and recognizes a transmission apparatus interconnected with the same RPR packet ring as the apparatus itself. For example, the transmission apparatus 204 and the transmission apparatus 205 can learn by the ATD frames received from the transmission apparatus 205 and the transmission apparatus 204, respectively, that the both transmission apparatuses are the transmission apparatuses interconnected with the same packet ring R1.

In the network including plural packet rings, two types of failure are assumed that are a connection failure between the packet rings and a failure of the connecting transmission apparatus within the packet ring.

FIG. 9 is a schematic for illustrating a connection failure between the packet rings. As shown in FIG. 9, it is assumed that a link (transfer system) failure 90 occurs between the transmission apparatus 104 and the transmission apparatus 205.

If a failure such as disconnection of a fiber is generated when the transmission apparatuses interconnecting the packet rings are directly connected, ring-down is detected (S91). Even if the apparatuses are not directly connected or if a failure occurs in the transfer system although the ring-down is not detected, it can be detected from the timer expiration of the keep-alive packet that the connectivity has been lost.

When it is detected that the connectivity of the packet rings has been lost between the transmission apparatus 104 and the transmission apparatus 205, the transmission apparatuses 104, 205 put the ring ID of the interconnection destination packet ring of the ATD frame into the NA state (S92). The interconnection transmission apparatus 103 and the transmission apparatus 204 perform the protection (1+1/1:1 switching, etc.) related to the inter-ring connection of the packet rings as necessary. For example, if the 1+1 protection has been employed and if the status has been STANDBY (backup), switching operation to ACT (active) is performed (S93). With this process, the traffic received from the opposite transmission apparatus is transferred onto the RPR ring.

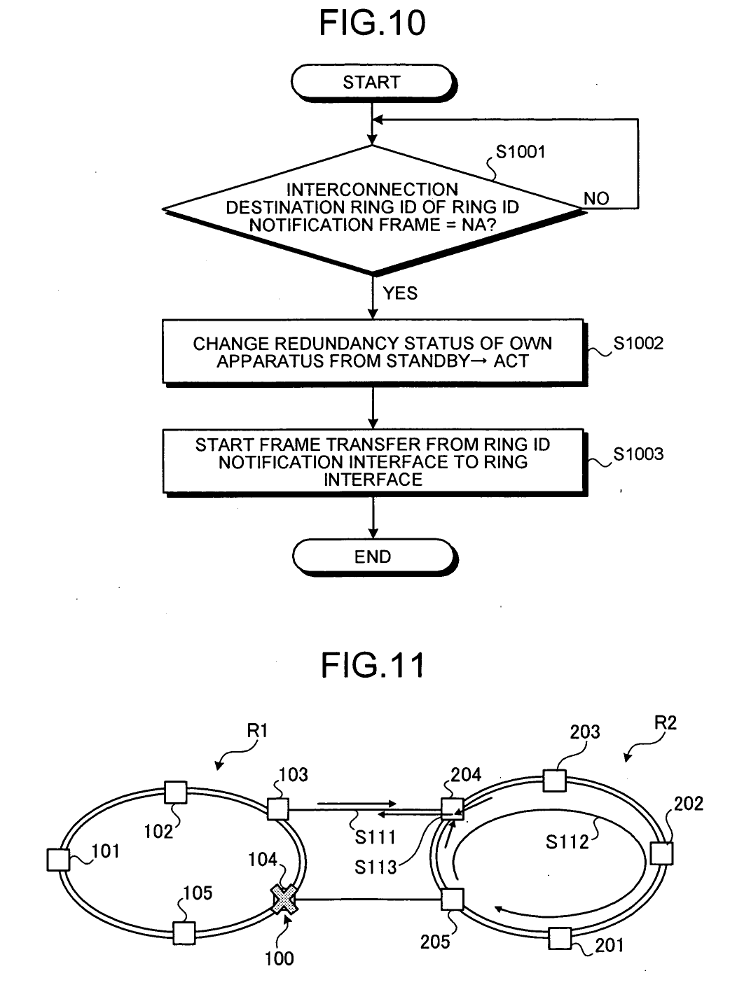

FIG. 10 is a flowchart of a process of a backup-system (STANDBY) transmission apparatus when the connection failure occurs between the packet rings with the 1+1 redundant configuration. First, it is determined whether the ring ID field of the interconnection destination is in the NA state in the ID frame from the transmission apparatus 205 (step S1001). Waiting until it is determined that the ring ID field is in the NA state (step S1001: No), when it is determined that the ring ID field is in the NA state (a failure is detected) (step S1001: YES), the redundancy status of the own apparatus is changed from STANDBY (backup) to ACT (active) (step S1002). Finally, the transfer of the ATD frame is started from the inter-ring connection interface to the ring interface (step S1003), and a series of the processes is terminated.

FIG. 11 is a schematic for illustrating a transmission failure of the transmission apparatus. As shown in FIG. 11, it is assumed that a control-system failure 100 occurs in the transmission apparatus 104 interconnecting the packet rings R1, R2.

Since the timer expiration of the keep-alive packet or the ring-down detection is generated (S111), the lost of the connectivity between the rings is recognized by the transmission apparatus 205 opposed to the transmission apparatus 104 where the failure 100 occurs. Therefore, the interconnection destination ring ID of the ATD frame is put into NA (S112). Another interconnection transmission apparatus 204 receives this ATD frame and performs the protection (1+1/1:1 switching, etc.) related to the inter-ring connection of the packet rings as needed. For example, if the 1:1 protection has been employed and if the status has been STANDBY (backup), switching operation to ACT (active) is performed (S113). With this process, the transfer of the traffic is started from the RPR ring to the opposite transmission apparatus.

The station-down of the transmission apparatus can be learned from the RPR protection by the transmission apparatus 103 interconnected on the same packet ring R1 as the transmission apparatus 104 where the failure occurs. On the packet ring R2, the protection operation is not particularly necessary for the interconnection.

Although description has been made of the case of using the ATD frame for the control frame, other control frames may be used, such as an organization operation administration maintenance (OAM) frame.

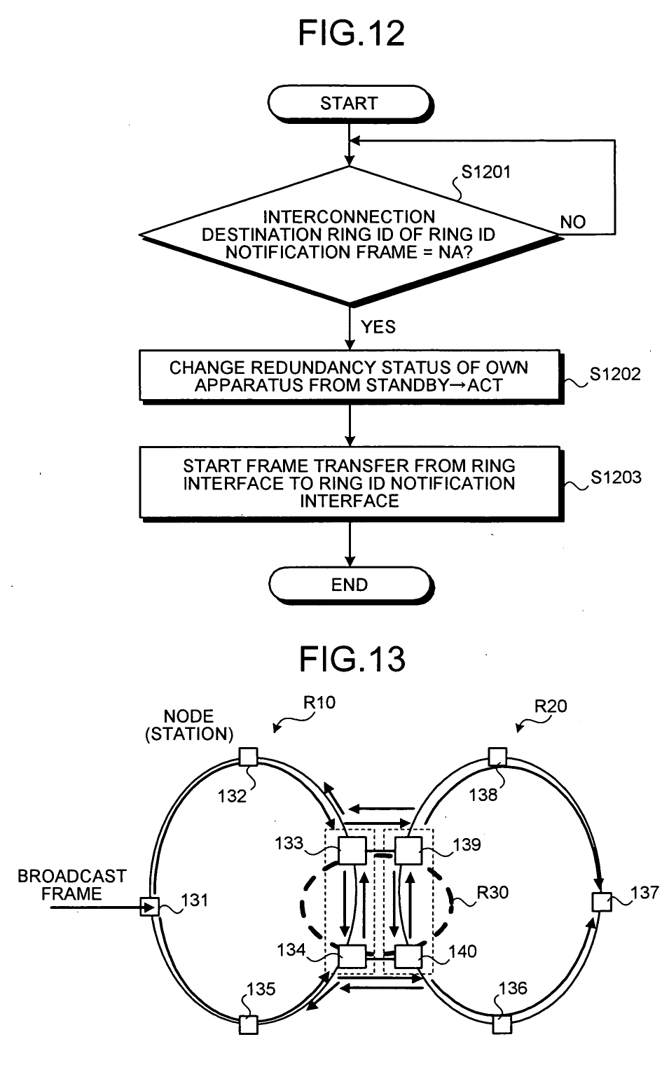

FIG. 12 is a flowchart of a process of a backup-system (STANDBY) transmission apparatus with the 1:1 redundant configuration in the connection destination ring when the transmission failure occurs in the transmission apparatus. First, it is determined whether the ring ID field of the interconnection destination is in the NA state in the ID frame from the transmission apparatus 205 (step S1201). Waiting until it is determined that the ring ID field is in the NA state (step S1201: No), when it is determined that the ring ID field is in the NA state (step S1201: YES), the redundancy status of the own apparatus is changed from STANDBY (backup) to ACT (active) (step S1202). Finally, the transfer of the ATD frame is started from the ring interface to the inter-ring connection interface (step S1203), and a series of the processes is terminated.

As described above, according to the embodiments of the present invention, the transmission channel rings are connected with the use of the transmission apparatuses and are automatically connected to establish a network without causing a network failure. Therefore, a work load on a user and a network administrator is reduced. Since the regulating control frame is used for the ID frame, the packet rings can be connected by transmitting only the requisite minimum packets, thereby reducing a load on the transmission channels.

The transmission-channel-ring connecting method described in the embodiments can be achieved by executing a program prepared in advance with transmission apparatuses such as routers and switches. This program is stored in a recording medium, such as a hard disk, a flexible disk, a compact-disc read-only memory, a magneto optical disk, and a digital versatile disk, that can be read by the transmission apparatus, and is read from the recording medium by the transmission apparatus for execution. This program may be a transmission medium distributed through a network such as the Internet.

According to the embodiments of the present invention, it is possible to establish a network without causing a network failure. Furthermore, it is possible to reduce a load on a user and a network administrator of the network.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A transmission apparatus arranged on a transmission channel ring on which pluralities of transmission apparatuses are arranged, the transmission apparatus comprising:
an acquiring unit configured to acquire connection information indicative of a connection state of the transmission apparatus with another transmission channel ring other than the transmission channel ring; and
a notifying unit configured to notify, to others of the transmission apparatuses arranged on the transmission channel ring, an interconnection state between the transmission channel ring and the other transmission channel ring based on the connection information by transmitting redundant configuration information indicative of the interconnection state.

2. The transmission apparatus according to claim 1, wherein the redundant configuration information is generated based on identification information identifying the other transmission channel ring, the identification information included in the connection information.

3. The transmission apparatus according to claim 1, further comprising:
a receiving unit configured to receive the redundant configuration information from the others of the transmission apparatuses arranged on the transmission channel ring; and
a generating unit configured to generate connection form information indicative of a form of connection of the transmission apparatuses within the transmission channel ring at the time of transmission of information, based on received redundant configuration information.

4. The transmission apparatus according to claim 1, wherein the notifying unit is configured to notify the interconnection state periodically.

5. The transmission apparatus according to claim 1, wherein the notifying unit is configured to notify, when the connection information is not acquired by the acquiring unit, that the redundant configuration information is currently invalid.

6. The transmission apparatus according to claim 5, further comprising a switching unit configured to switch an operation state of the transmission apparatus, wherein
the switching unit is configured to switch, when it is notified that the redundant configuration information is invalid by the notifying unit, the operation state to an active state if the operation state is currently a standby state.

7. The transmission apparatus according to claim 1, wherein the notifying unit is configured to notify, when the redundant configuration information has not been received by the receiving unit for a predetermined time period, that the redundant configuration information is currently invalid.

8. The transmission apparatus according to claim 7, further comprising a switching unit configured to switch an operation state of the transmission apparatus, wherein
the switching unit is configured to switch, when it is notified that the redundant configuration information is invalid by the notifying unit, the operation state to an active state if the operation state is currently a standby state.

9. The transmission apparatus according to claim 1, further comprising a transmitting unit configured to transmit the connection information of the transmission channel ring on which the transmission apparatus is arranged, to a transmission apparatus arranged on the other transmission channel ring to which the transmission apparatus is connected.

10. The transmission apparatus according to claim 9, wherein the connection information includes identification information identifying the transmission channel ring.

11. The transmission apparatus according to claim 9, wherein the transmitting unit is configured to periodically transmit the connection information to the transmission apparatus arranged on the other transmission channel ring.

12. The transmission apparatus according to claim 1, wherein the connection information and the redundant configuration information are transmitted by being inserted in a control frame.

13. The transmission apparatus according to claim 12, wherein the control frame includes an attribute discovery frame in a resilient packet ring.

14. The transmission apparatus according to claim 12, wherein the control frame includes an organization operation administration maintenance frame in a resilient packet ring

15. A method of connecting transmission channel rings on which pluralities of transmission apparatuses are arranged, the method comprising:
acquiring connection information indicative of a connection state of the transmission apparatus with another transmission channel ring other than the transmission channel ring; and
notifying, to others of the transmission apparatuses arranged on the transmission channel ring, an interconnection state between the transmission channel ring and the other transmission channel ring based on the connection information by transmitting redundant configuration information indicative of the interconnection state.

16. The method according to claim 15, further comprising transmitting the connection information of the transmission channel ring on which the transmission apparatus is arranged, to a transmission apparatus arranged on the other transmission channel ring to which the transmission apparatus is connected.

17. A computer-readable recording medium that stores therein a computer program for realizing a method of connecting transmission channel rings on which pluralities of transmission apparatuses are arranged, the computer program making a computer execute:
acquiring connection information indicative of a connection state of the transmission apparatus with another transmission channel ring other than the transmission channel ring; and
notifying, to others of the transmission apparatuses arranged on the transmission channel ring, an interconnection state between the transmission channel ring and the other transmission channel ring based on the connection information by transmitting redundant configuration information indicative of the interconnection state.

18. The computer-readable recording medium according to claim 17, wherein the computer program further makes the computer execute transmitting the connection information of the transmission channel ring on which the transmission apparatus is arranged, to a transmission apparatus arranged on the other transmission channel ring to which the transmission apparatus is connected.
